(19) United States
(12) Patent Application Publication
(10) Pub. No.: US 2010/0132125 A1
(43) Pub. Date: Jun. 3, 2010

(54) BIKE TOOL ASSEMBLAGE

(76) Inventor: Shu Te WU, Taichung Hsien (TW)

Correspondence Address: Guice Patents PLLC, 12647 Galveston Court #302, Manassas, VA, 20112, US

(21) Appl. No.: 12/610,572

(22) Filed: Nov. 2, 2009

(30) Foreign Application Priority Data
Dec. 1, 2008 (TW) 097146659

(51) Int. Cl. B25B 33/00

(52) U.S. Cl. 7/118

(57) ABSTRACT

A bike tool assemblage includes a first tool assembly and a second tool assembly. The first tool assembly has at least one first tool pivoted thereto, and the first tool is capable of rotation in a first plane. The second tool assembly has at least one second tool pivoted thereto, and the second tool is capable of rotation in a second plane. The first and the second tool assemblies are detachable to each other, which are characterized in: the first and second planes are not paralleled to each other, while the first and second tool assemblies are in combination. Thus, the first and second tools rotate in different directions.

### BACKGROUND

1. Field of the Invention

The present invention relates generally to a hand tool, and is more specifically concerned with a kit of bike tool.

2. Background of the Invention

Conventional bike multi-tool offers various sizes and types of tools, for example, U.S. Pat. No. 5,711,042, entitled “TOOL COMBINATION FOR BICYCLE”, or U.S. Pat. No. 6,622,329, entitled “3-PIECE BICYCLE TOOL ASSEMBLY”. The conventional bike multi-tool is composed of first and second sets of tools. Each set includes several tools, which are pivoted thereto. The first set of tools rotate in a first surface, while the second set of tools rotate in a second surface. The first and second sets could be combined to or separated from each other.

Due to light and portable requirements, the first and second sets are combined in back-to-back manner for shrinking the conventional bike multi-tool. After the combination, the first and second surfaces, in which the first and second sets of tools rotate, are overlapping or parallel to each other; as referring in FIGS. 3, 4 of U.S. Pat. No. 5,711,042, and referring in FIG. 2 of U.S. Pat. No. 6,622,329.

The conventional bike multi-tool discloses all tools rotate in the same direction because of the parallel of the first and second surfaces.

### SUMMARY OF THE INVENTION

A primary object of the present invention is to provide a bike tool assemblage of light and small volume; the tools in different tool assemblies rotate in different directions while the tool assemblies are in combination.

According to primary aspect of the present invention, a bike tool assemblage includes a first tool assembly and a second tool assembly. The first tool assembly has at least one first tool pivoted thereto, and the first tool is capable of rotation in a first plane. The second tool assembly has at least one second tool pivoted thereto, and the second tool is capable of rotation in a second plane. The first and the second tool assemblies are detachable to each other, which are characterized in: the first and second planes are not paralleled to each other, while the first and second tool assemblies are in combination. Thus, the first and second tools rotate in different directions.

The second tool assembly could includes two sub-assemblies connected together

### BRIEF DESCRIPTION OF THE DRAWINGS

These objects and advantages of the present invention will be more readily apparent after consideration of the following description in conjunction with the drawings.

FIG. 1 is a perspective view illustrating a bike tool assemblage of a first preferred embodiment according to the present invention;

FIG. 2 is a decomposition view illustrating part of a bike tool assemblage according to the first preferred embodiment;

FIG. 3 is a side view according to FIG. 1;

FIG. 4 is a perspective view illustrating an operation of the first preferred embodiment;

FIG. 5 is a perspective view illustrating a second preferred embodiment according to the present invention;

FIG. 6 is a decomposition view according to part of the second preferred embodiment

FIG. 7 is a sectional view of FIG. 5, in order to illustrate a second tool assembly engaging with a first tool assembly;

FIG. 8 is a side view according to FIG. 5;

FIG. 9 is a decomposition view illustrating a third preferred embodiment according to the invention;

FIG. 10 is a partial sectional view of FIG. 9;

FIG. 11 is a perspective view illustrating a fourth preferred embodiment according to the invention;

FIG. 12 is a decomposition view of part of FIG. 11;

FIG. 13 is a side view according to FIG. 11;

FIG. 14 is a perspective view illustrating a fifth preferred embodiment according to the invention;

FIG. 15 is a side view according to FIG. 14; and

FIG. 16 is a side view according to a sixth embodiment of the present invention.

### DETAILED DESCRIPTION OF PREFERRED EMBODIMENTS

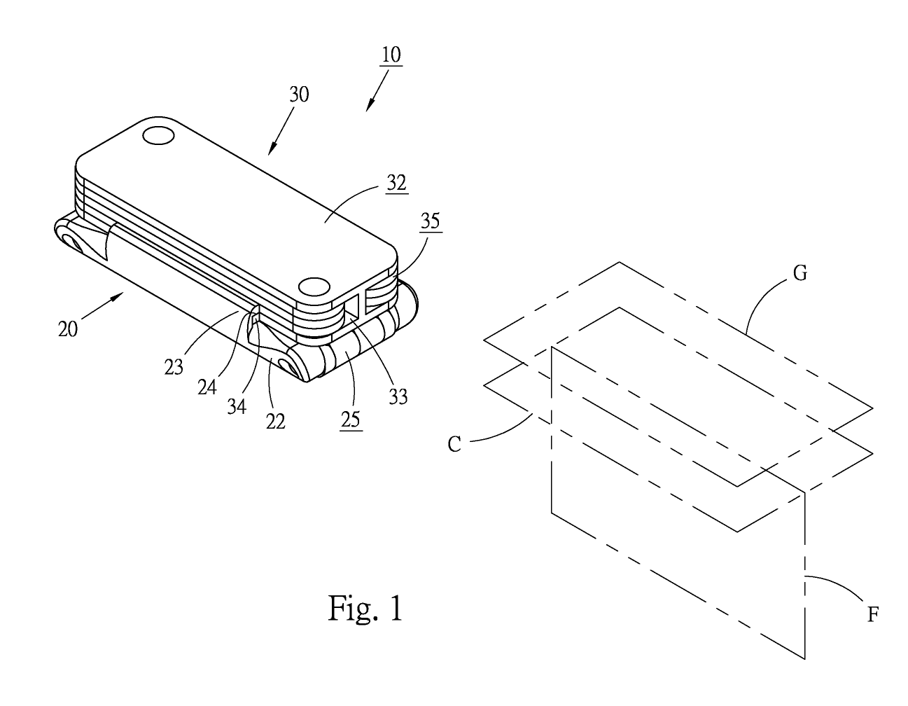

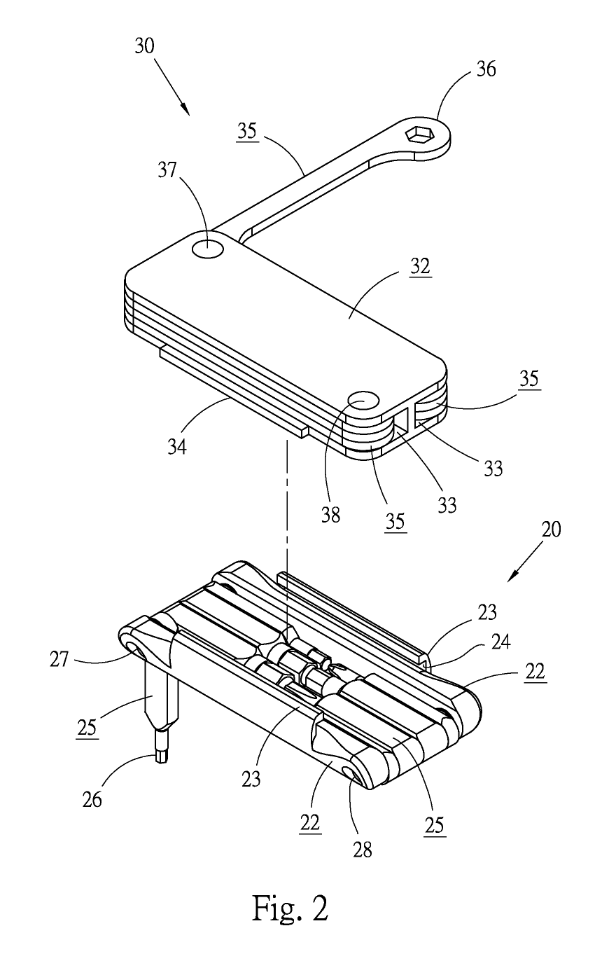

Certain embodiments as disclosed herein provide for a bike tool assemblage 10 of a first embodiment, referred in FIGS. 1 and 2, including a first tool assembly 20 and a second tool assembly 30.

The first tool assembly 20 is approximately flat; the first tool assembly 20 has two lateral plates 22, and a plurality of first tools 25 pivoted between the lateral plates 22 and respectively rotated about two shafts 27, 28, which are arranged therein. The two lateral plates 22 could be individual, or be relative as an integration one piece, such as in a U-shaped or H-shaped manner.

Each of the first tools 25 has an operation head 26 disposed at a free end thereof. The operation heads 26 are various and ranging from sizes to sizes, types to types; for example, the configuration of the operation heads 26 could be hexagon-shaped, slot-shaped or cross-shaped. Each of the two lateral plates 22 has a protrusion 23 extended upwardly from a top thereof, and a groove 24 formed at an interior face of the protrusion 23.

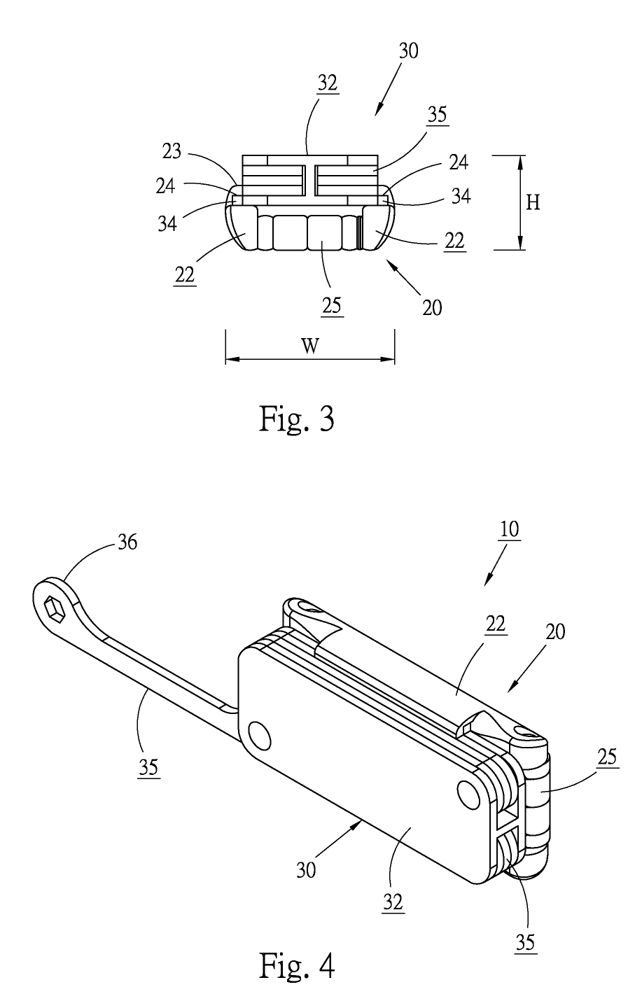

The second tool assembly 30 has a housing 32, and a plurality of second tools 35 pivoted to the housing 32. The housing 32 is of an I-shaped cross section, which allows two reception cavities 33 formed at two lateral sides thereof. The second tools 35 are respectively pivoted in the reception cavities 33 and rotated about shafts 37, 38, which are arranged to the housing 32. The housing 32 has two openings respectively formed at two lateral sides of the second tool assembly 30 and communicated with the two reception cavities 33, so that the second tools 35 could be stretched outwardly for operation from each lateral side of the second tool assembly 30. Each of the second tools 35 are approximately flat, and has an operation portion 36 disposed at a free end thereof. Each operation portion 36 has an enclosed opening, and the enclosed openings are various, ranging from sizes to sizes, to fit different sizes of nuts, bolts or the likes. The housing 32 has a bottom wall and two rims 34 respectively protruded from two lateral sides of the bottom wall. The two rims 34 of the second tool assembly 30 respectively engage with the grooves 24 of the first tool assembly 20, referred in FIGS. 1 and 3. Therefore, the two tool assemblies 20, 30 glide with each other for combination or separation.

Configurations of the tools of each tool assembly are not restrained by the drawings. For example, a tire lever for unloading the tire or a chain removal tool would be offered.

With respect to FIG. 1, the two tool assemblies 20, 30 are connected together as the bike tool assemblage 10. The first tools 25 are capable of rotation in first planes “F”, which are paralleled to each other; the second tools 35 are capable of rotation in second planes “G”, which are paralleled to each other. The second planes “G” are not paralleled to the first planes “F”, while the first and second tool assemblies 20, 30 are in combination. For example, an angle included between the first and second planes “F”, “G” could be 90 degree (vertical) or not. Thus, the first and second tools 25, 35 rotate in different directions. In addition, a combination plane “C” is formed at a conjunction between the two tool assemblies 20, 30. The first planes “F” are not paralleled to the combination plane “C”, an angle included between the first planes “F” and the combination plane “C” could be 90 degree (vertical) or not. The second planes are paralleled to the combination plane “C” or not. When the two tool assemblies 20, 30 are arranged one above the other, the combination plane “C” is a horizontal surface, the first planes “F” are perpendicular or approximately perpendicular to the combination plane “C”, and the second planes “G” are horizontal or are approximately horizontal surfaces.

Referred in FIG. 3, in combination, a height “H” of the bike tool assemblage 10, which is in the first planes “F”, is shorter than a width “W” thereof, which is in the second planes “G”. Therefore, the bike tool assemblage 10 would be light and small enough to be portable. Meanwhile, the height “H” is also short enough, as the bike tool assemblage 10 in combination, to adapt for narrow space, if a respective one of the second tools 35 is required for operation, referred in FIG. 4.

The quantity of the reception cavity is not restrained. Two reception cavities formed in the second tool assembly are not indispensable, and only one reception cavity should be fine.

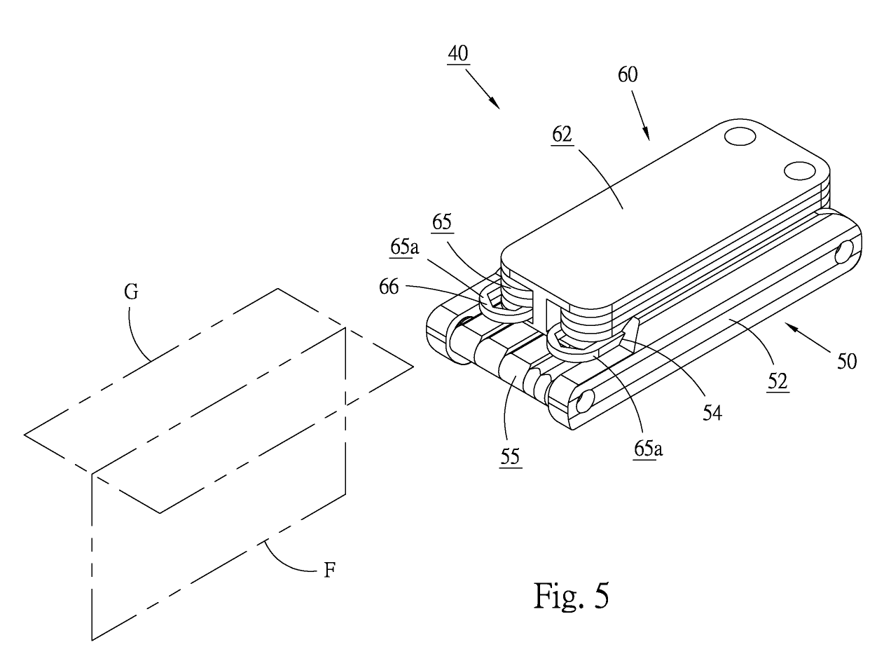

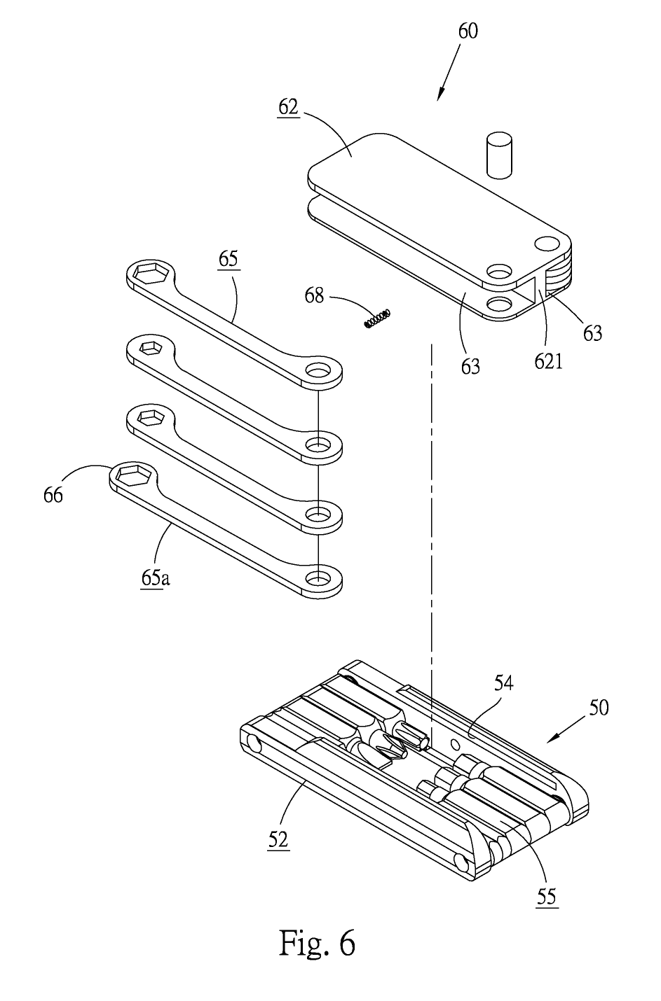

The second preferred embodiment according to the present invention is illustrated in FIGS. 5, 6. A bike tool assemblage 40 includes a first tool assembly 50 and a second tool assembly 60.

The configuration of the first tool assembly 50, approximately as same as the first tool assembly 20 in the first preferred embodiment, has two lateral plates 52, and a plurality of first tools 55 pivoted between the lateral plates 22.

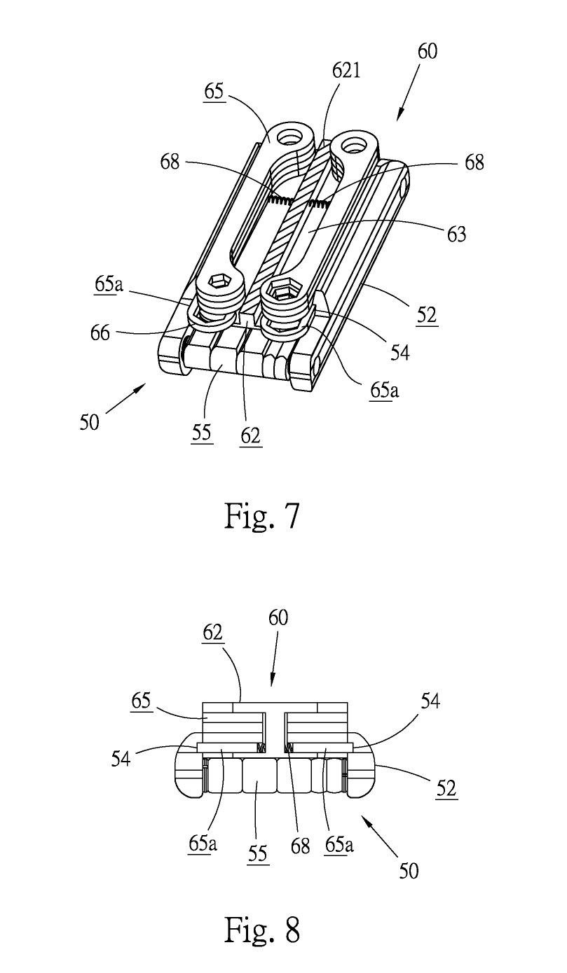

The second tool assembly 60, similar to the second tool assembly 30 in the first preferred embodiment, has a housing 52, and a plurality of second tools 65 respectively pivoted to the two lateral reception cavities 63 of the housing 62. With respect to FIG. 7, the second tool assembly 60 further includes two resilient members 68 respectively arranged in the reception cavities 63. Each resilient member 68 has an end against a partition wall 621 of the housing 62, and an opposite end against an inner side of a respective one of the second tools 65a. For example, the opposite end of the resilient member 68 could retain against the bottommost second tool. In general, two second tools 65a is swing-able toward a predetermined direction respectively due to the resilient members 68, so that the two swing-able second tools 65a could swing outwardly and stretch out of the housing 62 from lateral sides respectively. Preferably, the length of each swing-able second tool 65a is longer than others. A free end 66, which is also an operation portion, of each swing-able second tool 65a exposed out of an end of the housing 62. Each swing-able second tool 65a could move into the housing 62 by pressing the free end thereof.

While the combination is in require, the two swing-able second tools 65a could be pressed first to be received respectively in the reception cavities 63 and be prevented from stretching out. Then, move the second tool assembly 60 close to first tool assembly 50, and release the swing-able second tools 65a. Thus, the two swing-able second tools 65a could be swing again and stretch out respectively by the elasticity of the resilient members 68, and further respectively reach in the grooves 54 of the lateral plates 52 for engaging with the first tool assembly, shown in FIGS. 5, 7 and 8. After combination of the first and second tool assemblies 50, 60, the first planes “F”, which the first tools 55 rotate in, are not paralleled to the second planes “G”, which the second tools 65 rotate in.

While the separation is in require, the swing-able second tools 65a could be pressed inwardly to disengage from the grooves 64 so as to be able to remove the second tool assembly 60 from the first tool assembly 50.

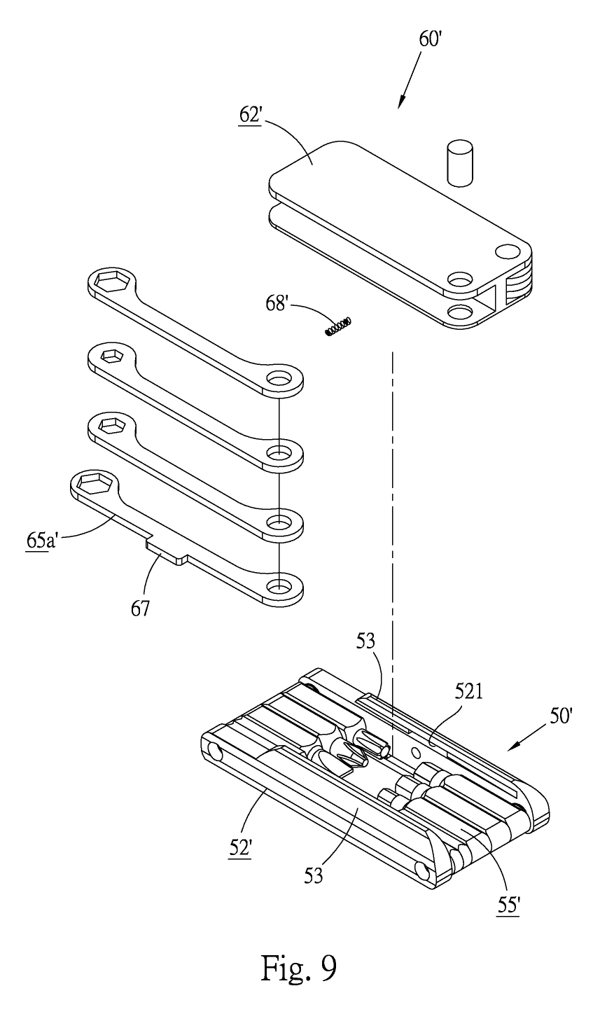

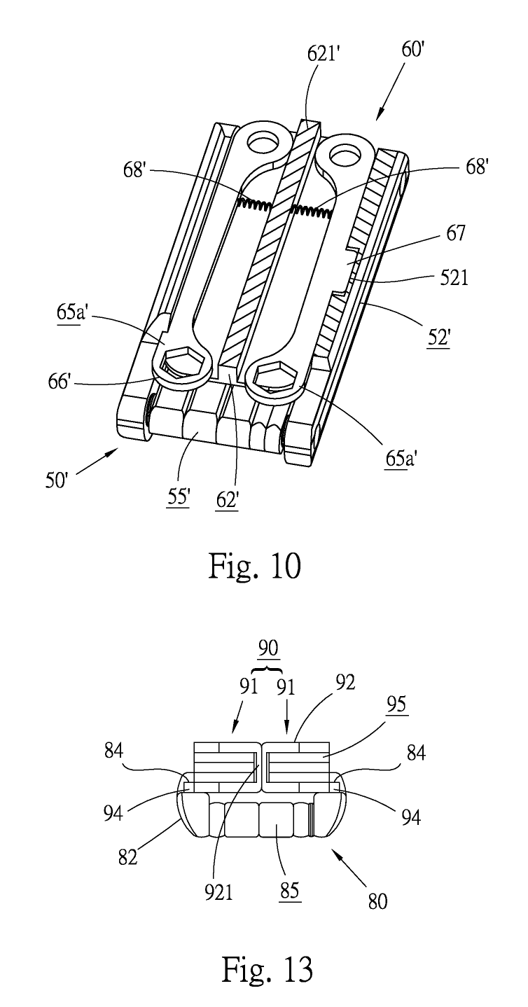

The third preferred embodiment according to the present invention is illustrated in FIGS. 9 and 10. The numbers in the third embodiment assigned to the same members are similar to the numbers in the second preferred embodiment.

The protrusion 53 of each lateral plate 52′ includes a mating recess 521 formed at an interior face of the protrusion 23

Each swing-able second tool 65a has a projection 67 formed at an exterior side thereof. When the two tool assemblies 50′ and 60′ are combined together, the projection 67 of the swing-able second tool 65a respectively engages with the mating recess 521 of the lateral plate 52′. Thus, there is no gliding between the two tool assemblies 50′ and 60′. The two swing-able second tools 65a are pressed to separate the projection 67 from the mating recess 521, so that the two tool assemblies 50′ and 60′ disengage from each other.

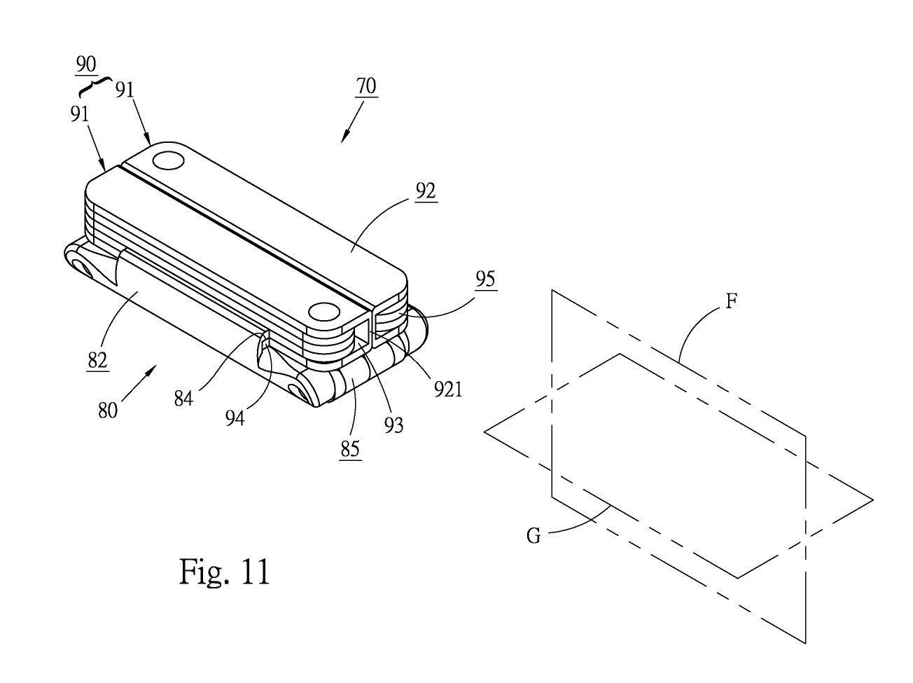

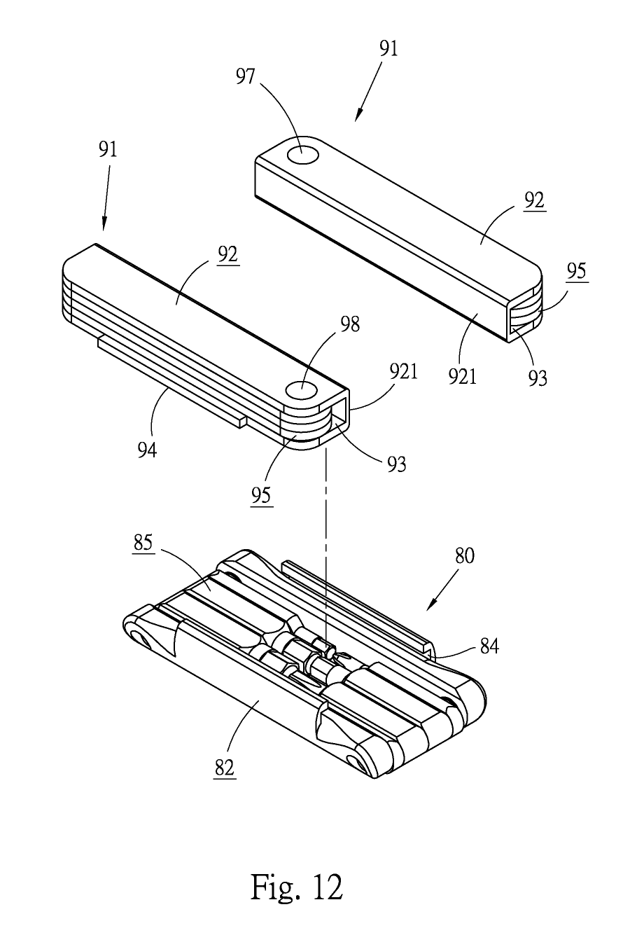

The fourth preferred embodiment of a bike tool assemblage 70 according to the present invention is illustrated in FIGS. 11 to 13. The bike assemblage 70 has a first tool assembly 80 and a second tool assembly 90. The configuration of the first tool assembly 80 is same with that in first embodiment.

The second tool assembly 90 substantially includes two sub-tool assemblies 91, which includes same sub-housing 92 of identical structure and size. Each sub-tool assembly 91 includes a reception cavity 93 formed in the sub-housing 92, and a plurality of the second tools 95 pivoted in the sub-housing 92 via shafts 97 and 98, which are arranged to the sub-housing 92. The cross section of each sub-housing 92 is approximately C-shaped. Each sub-housing 92 has a rim 94 extended outwardly from an exterior side of a bottom wall thereof.

In combination, the two sub-tool assemblies 91 are addorsed by two straight walls 921 thereof contacting each other, the second tool assembly 90 is symmetrical thereby via right half and left half. Put the two sub-tool assemblies 91 stay close, and each rim 94 thereof aligned the groove 84 of each lateral plate 82 for engaging with the first tool assembly 80. Thus, the two tool assemblies 80, 90 would combine together. Similarly, the second tool assembly 90 could glide in the first tool assembly 80 for combination or separation.

After combination, the second planes “G”, which the second tools 95 rotate in, are not paralleled to the first planes “F”, which the first tools 65 rotate in.

It makes sense that a resilient member could be also provided in each sub-tool assembly 91, such as in the second embodiment, to abut against a respective one of the second tools 95. The abutted second tool is forced to stretch out of the sub-housing 92. Therefore, the two sub-tool assemblies could engage with the first assembly 80.

To be necessary for description, the housing 32 in the first embodiment could be made as a whole by the two sub-tool assemblies 92 in this embodiment.

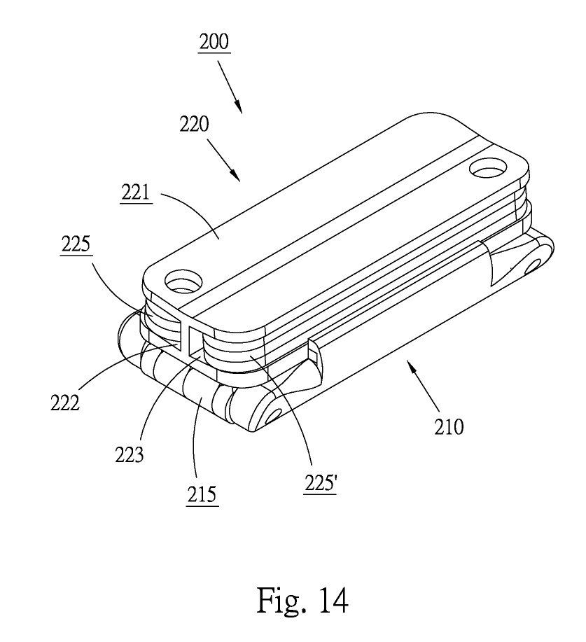

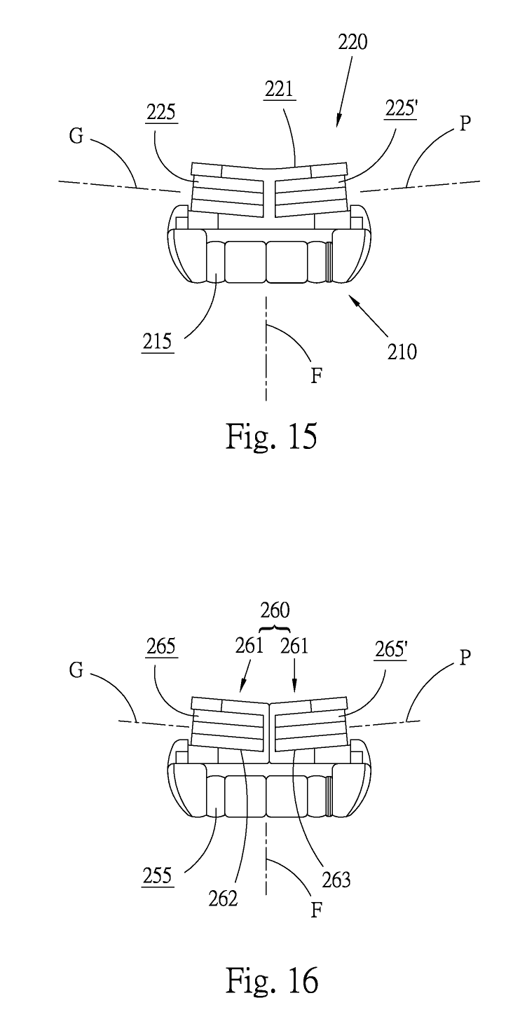

The fifth embodiment of a bike tool assemblage 200 according to the present invention, illustrated in FIGS. 14, 15, includes a first tool assembly 210 and a second tool assembly 220. The combination manners between the two tool assemblies 210 and 220 could just follow the first to third embodiments.

The first tools 215 of the first tool assembly 210 are capable of rotation in first planes “F”, which are paralleled to each other.

The second tool assembly 220 includes a housing 221, a first and second reception cavities 222, 223 formed at lateral sides of the housing 221, and a plurality of second tools respectively pivoted in the reception cavities 222, 223. The second tools 225 in the first reception cavity 222 are capable of rotation in second planes “G”, which are paralleled to each other. The second tools 225′ in the second reception cavity 223 are capable of rotation in third planes “P”, which are paralleled to each other. The second planes “G” are not paralleled to the third planes “P”; the three planes “F”, “G” and “P” are not paralleled to one another. Thus, the tools 210, 225 and 225′ rotate in different directions.

Additionally, a second tool assembly 260 illustrated in FIG. 16 is treated as a whole by two addorsed sub-tool assemblies 261, which are symmetrical to each other. The second tools 265, 265′ pivoted respectively in first and second reception cavities 262, 263. The planes “G”, which the second tools 265 rotate in, and the planes “P”, which the second tools 265′ rotate in, are neither paralleled to each other, nor paralleled to the planes “F”, which the first tools 255 rotate in.

The tools in the bike tool assemblage according to the present invention could rotate in different surfaces at the same time, and the bike tool assemblage also keeps light and small for high portability.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A bike tool assemblage comprising:
a first tool assembly having at least one first tool pivoted thereto, and the first tool being capable of rotation in a first plane;
a second tool assembly having at least one second tool pivoted thereto, and the second tool being capable of rotation in a second plane;
the first and the second tool assemblies being detachable to each other, which are characterized in:
the first and second planes are not paralleled to each other, while the first and second tool assemblies are in combination; the first and second tools rotate in different directions thereby.

2. The bike tool assemblage as claimed in claim 1, wherein the first and second planes are substantially perpendicular to each other.

3. The bike tool assemblage as claimed in claim 1, wherein the second tool assembly includes a housing, at least one reception cavity formed in the housing, and an opening formed at a lateral side of the housing and communicated with the reception cavity; at least one second tool is pivoted in the reception cavity and rotating in the second plane.

4. The bike tool assemblage as claimed in claim 1, wherein the second tool assembly includes a housing, two reception cavities formed at two lateral sides of the housing, and two openings respectively formed at two lateral sides of the housing and communicated with the reception cavities; at least one second tool is pivoted in each reception cavity.

5. The bike tool assemblage as claimed in claim 1, wherein the second tool assembly includes two sub-assemblies, and each sub-assembly has at least one second tool pivoted thereto; the two sub-assemblies are addorsed for combining with the first tool assembly; the second tool of at least one of the sub-assemblies rotates in the second plane.

6. The bike tool assemblage as claimed in claim 5, wherein each sub-assembly includes a sub-housing, a reception cavity formed in the sub-housing, and an opening communicated with the reception cavity; the openings are arranged at lateral sides of the second tool assembly, while two sub-assemblies are addorsed; the second tools are respectively pivoted in the two reception cavities.

7. The bike tool assemblage as claimed in claim 1, wherein the second tool assembly includes a first and a second reception cavities recessed at two lateral sides thereof, and at least one second tool is pivoted in each reception cavity; the second tool in the first reception cavity rotates in a second plane, while the second tool in the second reception cavity rotates in a third plane; the second plane is not paralleled to the third plane.

8. The bike tool assemblage as claimed in claim 1, wherein the two tool assemblies glide with each other for combination.

9. The bike tool assemblage as claimed in claim 1, wherein the first tool assembly includes two lateral plates, and at least one first tool is pivoted between the two lateral plates; the second tool assembly includes a housing, and at least one second tool is pivoted to the housing; the second tool assembly glides with the two lateral plates via the lateral sides of the housing.

10. The bike tool assemblage as claimed in claim 9, wherein each lateral plate of the first tool assembly has a protrusion extended upwardly from a top thereof, and a groove formed at an interior face of the protrusion; the housing of the second tool assembly includes a bottom wall and two rims respectively protruded from two lateral sides of the bottom wall; the two rims of the second tool assembly respectively engage with the grooves of the first tool assembly.

11. The bike tool assemblage as claimed in claim 5, wherein the first tool assembly includes two lateral plates, the first tool is pivoted between the two lateral plates; the second tool assembly slides to combine with the two lateral plates via an exterior side of a bottom wall of each sub-housing, while the two sub-assemblies are addorsed.

12. The bike tool assemblage as claimed in claim 11, wherein each lateral plate of the first tool assembly has a protrusion extended upwardly from a top thereof, and a groove formed at an interior face of the protrusion; the housing of the second tool assembly includes a bottom wall and two rims respectively protruded from two lateral sides of the bottom wall; the two rims of the second tool assembly respectively engage with the grooves of the first tool assembly.

13. The bike tool assemblage as claimed in claim 4, wherein the first tool assembly includes two lateral plates; the first tool is pivoted between the two lateral plates; a respective one of the second tools received in each reception cavity is swing-able toward a predetermined direction; the second tool assembly engage with the lateral plates of the first tool assembly via the two swing-able second tools.

14. The bike tool assemblage as claimed in claim 13, wherein each lateral plate has a mating recess; each swing-able second tool has a projection formed at an exterior side thereof for engaging with the mating access.

15. The bike tool assemblage as claimed in claim 13, wherein each swing-able tool has a free end exposed out of the second tool assembly.

16. The bike tool assemblage as claimed in claim 13, wherein the second tool assembly has a resilient member arranged in each reception cavity; each swing-able second tool is abutted against by the resilient member to swing outwardly.

17. The bike tool assemblage as claimed in claim 1, further including a height in the first plane and a width in the second plane, while the first and second tool assemblies are in combination; the width is greater than the height.

18. The bike tool assemblage as claimed in claim 1, wherein the first tool assembly includes two lateral plates; the first tool is pivoted between the two lateral plates; the second tool assembly includes a housing; the second tool is pivoted in the housing; the second tool assembly combine with the first tool assembly by the lateral sides of the housing engaging with the lateral plates.

19. The bike tool assemblage as claimed in claim 1, wherein the second tool is flat.

20. A bike tool assemblage comprising:
a first tool assembly having at least one first tool pivoted thereto, and the first tool being capable of rotation in a first plane;
a second tool assembly having at least one second tool pivoted thereto, and the second tool being capable of rotation in a second plane;
the first and the second tool assemblies being detachable to each other, which are characterized in:
a combination plane being formed at a conjunction between the two tool assemblies, while the first and second tool assemblies are in combination; the first plane is vertical or approximately vertical, and the second plane is horizontal or approximately horizontal, when the combination plane is horizontal; whereby the first and second tools rotate in different directions.
